(19) United States
(12) Patent Application Publication
(10) Pub. No.: US 2022/0263308 A1
(43) Pub. Date: Aug. 18, 2022

(54) SYSTEM FOR PROTECTING AN ELECTRICAL SOURCE OR ELECTRICAL LOAD

(71) Applicant: DEHN SE + CO KG, Neumarkt (DE)

(72) Inventors: Franz Schork, Neumarkt (DE); Thomas Böhm, Neumarkt (DE); Andreas Waigel, Neumarkt (DE); Stefan Dietweger, Neumarkt (DE); Sabine Wildfeuer, Neumarkt (DE)

(21) Appl. No.: 17/609,978

(22) PCT Filed: May 6, 2020
(86) PCT No.: PCT/EP2020/062486

§ 371 Date: Nov. 9, 2021

(30) Foreign Application Priority Data
May 16, 2019 (DE) 10 2019 112 951.6

(51) Int. Cl. H02H 3/10; H02H 1/00

(52) U.S. Cl. CPC H02H 3/10; H02H 1/0007

(57) ABSTRACT

The invention relates to a system for protecting an electrical source or an electrical load, having a module comprising an input and an output, and an electronic safety device for the load that can be connected to the source. The module also comprises a voltage monitoring unit, a current monitoring unit, and semiconductor switching units and controllers associated therewith. According to the invention, in order to selectively apply the protection to the source or the protection to the load, a unit for electrical mirroring on the circuit side is provided so that in the event of source protection, the current monitoring unit is applied at the input end and the voltage monitoring unit is applied at the output end, and in the event of load protection, the voltage monitoring unit is applied at the input end and the current monitoring unit is applied at the output end.

The invention is based on a system for protecting an electrical source or an electrical load, having an assembly that has an input and an output and comprises an electronic fuse for the load that can be connected to the source, and also a voltage monitoring unit, a current monitoring unit and semiconductor switching units and controllers associated therewith, wherein, after the fuse has responded owing to an overvoltage event, said fuse can be reset, as claimed in the preamble of claim 1.

Electronic fuses, in a wide variety of embodiments, form part of the prior art. Typical operating ranges of said fuses are in the region of up to 200 A for voltage classes between 12 and 100 volts DC.

Overvoltage protection devices based on varistors, gas arresters, spark gaps or the like are furthermore known for protecting DC voltage networks and consumers connected to DC voltage networks.

If overvoltage protection devices of the known type and electronic fuses are not used in a coordinated way, uncontrollable problems arise, which lead to undesired tripping of the fuse or an unintentional response of the overvoltage protection apparatuses and therefore impermissibly long downtimes. For industrial applications in particular, downtimes of this kind have to be avoided. It is also important to eliminate the previously conventional, manual reactivation of protective devices.

U.S. Pat. No. 5,875,087 A discloses a protective device with integrated control for protecting electrical systems, wherein a combination of overvoltage and overcurrent protection for AC networks with an automatic reset is disclosed therein.

A safety device for a rechargeable electrical energy store has already been disclosed in DE 10 2015 105 426 A1. In this regard, the intention is to allow rapid suppression or interruption of a flow of electric current in the presence of abnormal parameters. According to the teaching therein, a plurality of semiconductor switching units are used for the primary, reversible suppression of the flow of current as a function of the monitoring of the flow of current and/or voltage. A switching unit that can be pyrotechnically triggered is present for the irreversible suppression of the flow of current.

A controlled series member that is switched on or off as a function of the current and the voltage has already been disclosed in WO 2011/070235 A1. There is no distinction made between temporary overvoltages and transient overvoltages therein. Likewise, there is no galvanic isolation in the case of temporary overvoltages that are above the blocking ability of the semiconductors in the series branch. In this case, overvoltage protection is only possible to a limited extent since there is no coarse protection element attached upstream of a series element.

DE 10 2004 036 164 A1 discloses a controlled series and a controlled parallel member. Protection against high-power transient overvoltages is not involved here, since the proposed arrangements of the series and parallel member do not permit this.

US 2006/0120000 A1 relates to a pure electronic fuse having the feature that the fuse opens the series member if the input voltage is exceeded. There is no transient overvoltage protection at the input, however.

DE 10 2017 109 378 A1 relates to an electronic fuse for a load that can be connected to a low-voltage DC voltage network and forms a starting point for the teaching of the present application.

This electronic fuse for a load that can be connected to a low-voltage DC voltage network consists of assemblies arranged between input terminals and the load. Said assemblies comprise a voltage monitoring unit, a current monitoring unit and also semiconductor switching units and controllers associated therewith. The assemblies used are polarized on account of the properties of the semiconductor switches and, considered electrically, can be operated only in a manner dependent on the current direction.

The object of DE 10 2017 109 378 A1 is to specify a further developed electronic fuse for a load that can be connected to a low-voltage DC voltage network, completely dispenses with mechanical switching elements or switching devices and is capable of guaranteeing reaction times in the nanosecond range. The electronic fuse is intended to guarantee protection against overvoltages, but also overcurrents, in a combined manner. Once an overvoltage event has ended, the electronic fuse is intended to pass into the normal operating state automatically without needing manual intervention.

In the case of the fuse explained therein, there is an evaluation of the respective events by integrated logic using a microcontroller. Load short circuits can therefore be evaluated separately from overvoltage events. If an overvoltage event causes the fuse to respond, said fuse can be reset again by the microcontroller after the overvoltage, such that a failure in the system to be protected, or the load, does not occur.

In the case of the solution therein, it is no longer necessary to implement overvoltage protection and overcurrent protection by way of two circuit units or apparatuses. External assessment of the system after the fuse has been tripped is no longer necessary. It is likewise unnecessary to externally reactivate a fuse that has responded. With respect to the details of the electronic fuse implemented, the description as per DE 10 2017 109 378 A1 is indicated and reference is made thereto.

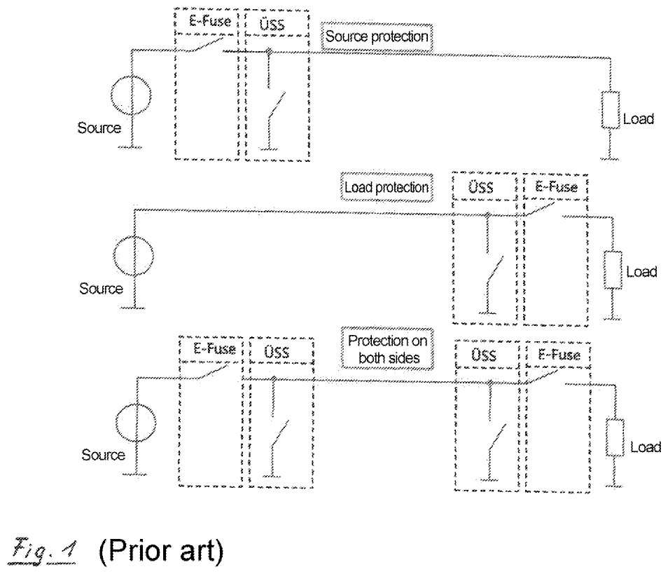

In principle, the prior art in the case of the structure of protective systems with combined overcurrent and overvoltage protection is represented with reference to FIG. 1 and the illustrations therein. It is clear from these figurative illustrations that, for protecting a load, overvoltage protection is implemented at the input side and overcurrent protection is implemented at the output side, appropriately close to the load. When protection of a source is concerned, overcurrent protection is applied at the input side of the protective assembly and overvoltage protection is applied at the output side. When protection on both sides, that is to say source protection and load protection, is intended to be implemented, two appropriate protective units are required.

This results in the need to provide different types of apparatus for load protection, but also for source protection.

It is therefore an object of the invention to specify a system for protecting an electrical source or an electrical load, which can be implemented using a single apparatus, wherein there is the possibility of such an apparatus being preconfigured on the part of the manufacturer, but the user is also given the option of carrying out configuration depending on the desired application.

The object is achieved with a system for protecting an electrical source or an electrical load, in particular in low-voltage DC voltage networks in accordance with the combination of features as claimed in claim 1, wherein the dependent claims represent at least expedient configurations and refinements.

The basic principle of the invention is based on the idea of eliminating the directional dependency of semiconductor switching units used by way of the polarity of such a direction-dependent switch being reversed by changing its relative position in the circuit and the relevant circuit being mirrored.

The fundamental mirror symmetry relating to current and voltage protection is therefore exploited here, and electrical mirroring ensures that one and the same apparatus can be used in an optimum manner both for protection of a source and for protection of a load. As a result, there can be substantial standardization of relevant apparatuses and storage and stock-keeping can be reduced.

A base part of the system accommodates the actual overvoltage and overcurrent protection in a separate housing. The electrical mirroring or option of polarity reversal is implemented with the aid of a configurator part, preferably in the form of a plug-on module.

Thus, a system for protecting an electrical source or an electrical load, which has an assembly comprising an input and an output, is assumed. The assembly includes an electronic fuse for the load that can be connected to the source, and also a voltage monitoring unit, a current monitoring unit and semiconductor switching units and controllers associated therewith. A protective device of this kind is already known in principle from the prior art, as outlined at the beginning.

A unit for circuit-side electrical mirroring is provided for the selective use of the source protection or the load protection in such a way that, in the case of source protection, the current monitoring unit is applied at the input side and the voltage monitoring unit is applied at the output side.

In the case of load protection, the voltage monitoring unit is present at the input side and the current monitoring unit is present at the output side.

In this regard, as a refinement, the system comprises a plug or switching unit for electrical mirroring with means for selectively connecting the current monitoring unit to the input or the output of the assembly.

The assembly of the system therefore has an input and an output and consists of an electronic fuse for the load that can be connected to the source, and also a voltage monitoring unit, a current monitoring unit and semiconductor switching units and controllers associated therewith. If the fuse responds owing to an overvoltage event, said fuse can be reset. The above-mentioned assembly is located in a base part. The plug or switching unit is located in a separate configurator part, wherein means for selectively fixing the configurator part are formed on the base part.

The configurator part can be embodied as a plug part with a plug contact or plug sockets and can have appropriate electrical wiring for the purpose of the desired electrical mirroring.

The plug contacts or the plug sockets are complementary to mating contacts or mating contact sockets in the base part.

The desired electrical mirroring can be carried out in a simple way by removing the configurator part and reattaching it to the base part rotated by 180°, for example.

The configurator part can also have switches or changeover switches for circuit-side mirroring, however. In this respect, they can be pushbutton switches, press buttons, lever switches, or the like.

Furthermore, the configurator part can have means for displaying the selected interconnection or mirroring, for disconnection and/or for data logging. There can therefore be further functions provided in the configurator part.

In one configuration of the invention, a plurality of configurator parts can be fixed on the base part in order to implement the desired circuit design for the relevant application.

There is also the possibility of designing a plurality of base parts so that they can be arranged mechanically adjacently to one another, wherein said base parts can be interconnected, in particular can be connected in series, by way of a configurator part in the form of a multiple connector.

Furthermore, electrical properties or parameters of the current and/or voltage monitoring unit can be changeable or predefinable by means of the configurator part. In this sense, parameterization can be carried out.

The properties and parameters of the configurator part can be identified by way of its shape, haptics and/or coloration, thereby precluding incorrect interconnection by the user.

In a refinement of the invention, the polarity of a direction-dependent switch, in particular a semiconductor switch, in turn in particular a MOSFET here, can be reversed in the context of the desired mirroring by means of the configurator part, that is to say that the position of the semiconductor switch in the circuit is changed on the basis of the overvoltage protection.

In principle, there is, however, also the possibility not only of arranging passive component parts such as plug contacts and conductor tracks in the configurator part, but also of integrating an active component therein; this can be a semiconductor switch here, in particular.

The invention is to be explained in greater detail using an exemplary embodiment and with reference to figures.

In the figures:

FIG. 1 shows basic illustrations of the prior art in the case of the structure of protective systems with combined overcurrent and overvoltage protection, wherein the overcurrent protection is denoted by E-Fuse and the overvoltage protection is denoted by USS and source and load are illustrated, with an embodiment of primary source protection (upper image), primary load protection (central image) and protection on both sides with two protective assemblies (lower image);

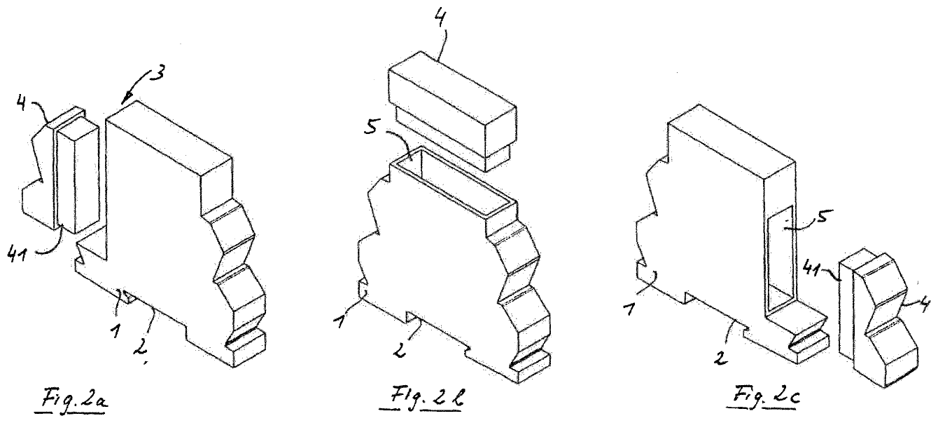

FIGS. 2a-2c show different illustrations of the design of a base part with the required current and voltage monitoring units integrated therein and a cutout for accommodating corresponding configurator parts that, according to FIGS. 2a and 2c, accommodate a partial molding or partial casing of the housing configuration of the base part or change into such a form;

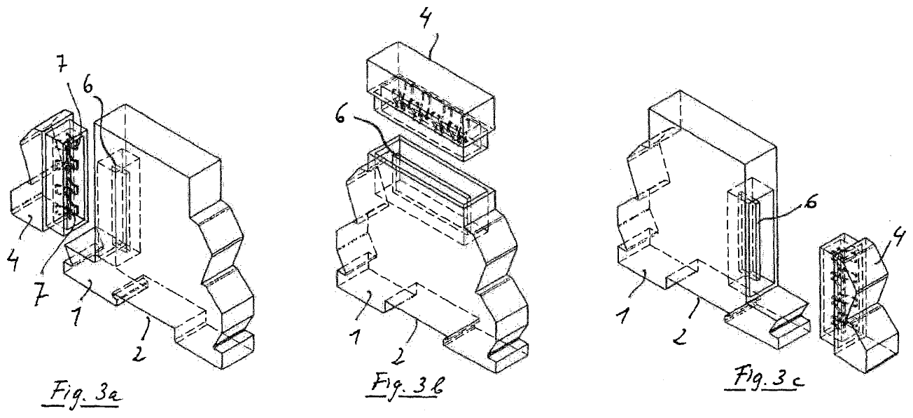

FIGS. 3a-3c show illustrations similar to those shown in FIGS. 2a-2c, but with identifiable electrical contacts in the respective configurator part that are complementary to an indicated printed circuit board in the base part and contact surfaces present there in order to carry out electrical mirroring of the assembly located in the base part, depending on the position and arrangement of the configurator part;

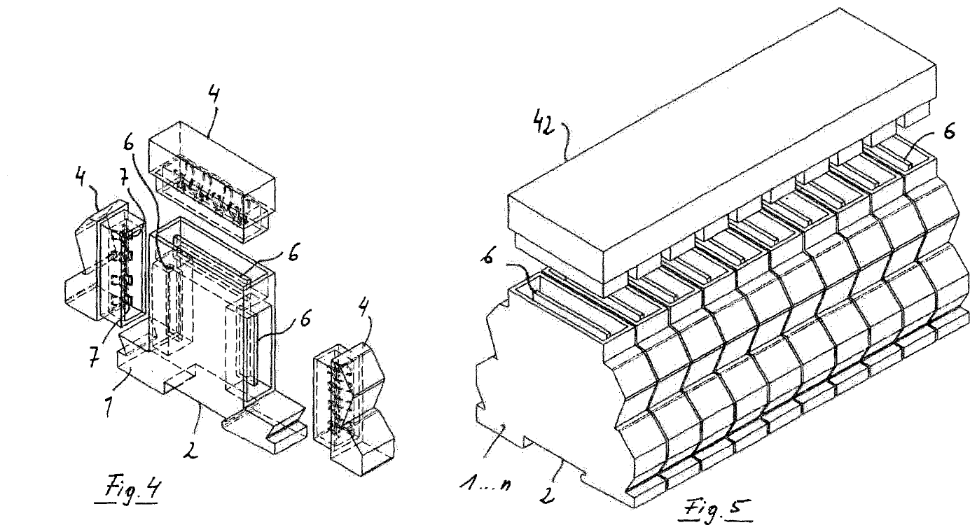

FIG. 4 shows an illustration of a base part with a plurality of recesses present at the end sides for the mechanical and electrical fixing of different configurator parts and plug elements located there for implementing the electrical mirroring and for parameterizing the assembly located in the base part; and

FIG. 5 shows a perspective illustration of the mechanical adjacent arrangement of a multiplicity of (ten, in the example shown) base parts that are mechanically and electrically interconnected, in particular are mechanically and electrically interconnected in series, by way of a compact configurator part and can be mirrored internally electrically in the circuitry by rotation of the configurator part by 180°, for example.

As illustrated in FIGS. 2a to 2c, the system according to the invention for protecting an electrical source or an electrical load consists of an electrical assembly that has an input and an output. This assembly comprises an electronic fuse for the load that can be connected to a source, and also a voltage monitoring unit, a current monitoring unit and semiconductor switching units in addition to controllers associated therewith. These above-mentioned assemblies are located in the housing arrangement, that is to say within the base part 1.

The base part 1 is provided with a recess 2 on its bottom side for DIN rail mounting.

According to FIG. 2a there is a recessed section 3 on a left-hand narrow side of the base part 1.

A configurator part 4 that has in its section 41 plug contacts or plug sockets, switches or changeover switches or similar means, which are not shown, for electrical mirroring of the assembly within the base part 1 can be plugged into this recessed section 3.

The configurator part 4 can have a contour that corresponds to the casing, that is to say the basic shape, of the base part 1 and in this respect completes it.

FIG. 2c shows a design, which is mirror-symmetrical in this regard, of a base part 1 with a recessed section formed on the right-hand narrow side and the configurator part 4 with a section 41. FIG. 2c also makes it clear how the configurator part 4 can be inserted into an opening section 5 of the base part.

FIG. 2b shows an embodiment with a configurator part 4 as a variant that can be inserted from above into a corresponding section 5 of the base part 1.

FIGS. 3a to 3c are matched to the illustrations of FIGS. 2a to 2c and illustrate a possible structure and a possible arrangement of a wiring carrier, that is to say an exemplary printed circuit board 6, within the respective base part 1.

The printed circuit board 6 has contact surfaces, which are not shown, that correspond to contact terminals or contact connectors 7 in the respective configurator part 4 in order to allow, depending on the insertion position, polarity reversal of the corresponding assembly that is located on the printed circuit board and implemented there.

According to the illustration in FIG. 4, it is possible to form a configurator part not only on one of the end sides of the plug part 1 accessible during usual operation, but on all or a plurality of sides so as to implement different functionalities. In this case, parameterization of the assembly located in the base part 1 can also be carried out with the aid of an appropriately configured configurator part 4.

In the example shown in FIG. 5c, a mechanical adjacent arrangement of a plurality of base parts can be interconnected with the aid of a common compact configurator part 42, designed as a multiple connector.

In this case, with the aid of the uniform configurator part 42, both a series circuit of the corresponding assemblies within the base parts 1 and the desired mirroring can be achieved by virtue of the configurator part 42, which is withdrawn and rotated by 180°, being brought into connection again with the corresponding recesses in the respective base parts 1.

The invention accordingly constitutes a system for combined overcurrent and overvoltage protection that protects both source and load and in this respect can be arranged close to the load and close to the source, wherein the respective functionality by way of electrical mirroring can be selected only by way of a simple, mechanically releasable configurator part.

The actual overvoltage and overcurrent protection is located in the base part. In contrast, the means for electrical mirroring are implemented in the removable configurator part and housed there.

A display function can also additionally be integrated in the configurator parts. This display can serve to illustrate whether the configurator part is inserted precisely and has been inserted in such a way that the necessary solution for source or load protection is available.

For the purpose of the above-mentioned parameterization of the assembly in the base part, the configurator parts can have different shunts, for example, in order to alter the selectivity or sensitivity of the overcurrent protection. There is also the possibility of integrating a fuse into the configurator part as galvanic isolation for active semiconductor components that are located in the base part and are constituent parts of the assembly. This would make it possible to simply change such a fuse, since it does not have to engage into the base part.

The configurator part therefore forms an essential component part of an electrical mirroring assembly that is provided for changing the order of overvoltage and overcurrent protection in the assembly located on the base part such that the system can be used appropriately close to the source or close to the load for optimum source protection or optimum load protection.

1. A system for protecting an electrical source or an electrical load, having an assembly that has an input and an output and comprises an electronic fuse for the load that can be connected to the source, and also a voltage monitoring unit, a current monitoring unit and semiconductor switching units and controllers associated therewith, wherein, after the fuse has responded owing to an overvoltage event, said fuse can be reset,
characterized in that
a unit for circuit-side electrical mirroring is provided for the selective use of the source protection or the load protection in such a way that, in the case of source protection, the current monitoring unit is applied at the input side and the voltage monitoring unit is applied at the output side, and in the case of load protection, the voltage monitoring unit is applied at the input side and the current monitoring unit is applied at the output side.

2. The system as claimed in claim 1,
characterized in that
said system comprises a plug or switching unit for electrical mirroring with means for selectively connecting the current monitoring unit to the input or the output of the assembly.

3. The system as claimed in claim 1,
characterized in that
the assembly, consisting of an electronic fuse for the load that can be connected to the source, and also a voltage monitoring unit, a current monitoring unit and semiconductor switching units and controllers associated therewith, is arranged in a base part (1) and the plug or switching unit is located in a separate configurator part (4; 42), wherein means for selectively fixing the configurator part (4; 42) are formed on the base part (1).

4. The system as claimed in claim 3,
characterized in that
the configurator part (4; 42) has plug contacts or plug sockets and electrical wiring, wherein the plug contacts or plug sockets are complementary to mating contacts or sockets in the base part (1).

5. The system as claimed in claim 3,
characterized in that
the configurator part (4; 42) has switches or changeover switches for circuit-side mirroring of at least parts of the assembly in the base part (1).

6. The system as claimed in claim 3,
characterized in that
means for displaying the selected interconnection or mirroring, for disconnection and/or for data logging are formed in the configurator part (4, 42).

7. The system as claimed in claim 3,
characterized in that
a plurality of configurator parts (4) can be fixed on the base part (1).

8. The system as claimed in claim 3,
characterized in that
a plurality of base parts (1) are designed so that they can be arranged adjacently to one another, wherein said base parts can be interconnected, in particular can be connected in series, by way of a configurator part in the form of a multiple connector (42).

9. The system as claimed in claim 3,
characterized in that
electrical properties or parameters of the current and/or voltage monitoring unit can be changed or predefined by means of the configurator part (4).

10. The system as claimed in claim 3,
characterized in that
the parameters of the configurator part (4; 42) can be identified by way of its shape, haptics or coloration.

11. The system as claimed in claim 3,
characterized in that
the polarity of a direction-dependent switch, in particular a semiconductor switch, located in the base part (1) can be reversed by means of the configurator part (4; 42).
